(19) United States
(12) Patent Application Publication
(10) Pub. No.: US 2012/0155459 A1
(43) Pub. Date: Jun. 21, 2012

(54) CONVERGED MESSAGING ACROSS LEGACY AND IP DOMAINS

(75) Inventor: Jean-Luc R. Bouthemy, Sammamish, WA (US)

(73) Assignee: T-Mobile USA, Inc., Bellevue, WA (US)

(21) Appl. No.: 12/975,353

(22) Filed: Dec. 21, 2010

(51) Int. Cl. H04L 12/56

(52) U.S. Cl. 370/389

(57) ABSTRACT

Communicating messages between multiple devices is described. In one aspect, a message is received from a packet-switched device and intended for a legacy destination device. If the size of the content in the message exceeds a threshold value, the content is stored while a second message is created that has a link to the stored content. That second message is communicated to the destination device. If the size of the content in the message does not exceed a threshold value, the message is translated into a format associated with the destination device and the translated message is communicated to the destination device.

### BACKGROUND

The increasing use of mobile devices, such as cellular phones, smart phones, Machine-to-Machine (M2M) devices, and notebooks, is creating a corresponding increase in messages and other data sent through various mobile communication networks. Many mobile devices use Short Message Service (SMS) or Multimedia Messaging Service (MMS) to communicate messages to other devices, such as other mobile devices. SMS allows devices to send short messages (e.g., text messages) to other devices. SMS messages are typically limited to 160 7-bit characters (140 8-bit characters or 70 16-bit characters). Larger messages may be carried over SMS over networks based on standards defined by 3^{rd} Generation Partnership Project (3GPP) such as Global System for Mobile Communications, GSM; Enhanced Data Rates for GSM Evolution, EDGE; General Packet Radio Service, GPRS; Universal Mobile Telecommunications System (UMTS) and High Speed Packet Access (HPSA). These SMS messages are known as “concatenated SMS”, “multipart SMS” or “segmented SMS”. MMS is an improvement over SMS; MMS supports the communication of messages containing multimedia content (such as audio files and pictures) between two or more devices.

Communication systems that support SMS and MMS have been in operation for many years and represent a significant investment by telecommunication companies. However, many newer devices use different communication systems, such as IP Multimedia Subsystem (IMS). IMS defines a system for communicating multimedia messages and other services between/among devices. In many situations, these newer devices do not support the SMS and MMS messaging services. This presents a problem to users of these newer devices that want to communicate messages to and from users with older devices that only support SMS or MMS. This also presents a problem to telecommunication companies and other service providers that have significant investments in the equipment and infrastructure related to SMS and MMS. Therefore, it is desirable to provide systems and methods that allow SMS and MMS devices to communicate with newer communication systems, such as IMS or based on Extensible Markup Language (XML) (such as Extensible Messaging and Presence Protocol, XMPP).

### BRIEF DESCRIPTION OF THE DRAWINGS

In the Figures, the left-most digit of a component reference number identifies the particular Figure in which the component first appears.

FIG. 1 shows an exemplary environment capable of implementing systems and methods for converged messaging across legacy and IP domains, according to one embodiment.

FIG. 2 shows an exemplary procedure for converged messaging, responsive to receipt of a page mode IM message, which may be delivered to legacy and IP domains, according to one embodiment.

FIG. 3 is a flowchart illustrating delivery of instant message (large message mode, pager mode, pager mode with content indirect, and session-based mode), MMS and SMS regardless of the initial chosen method (IM, MMS, or SMS), according to one embodiment.

FIG. 4 is a flowchart showing exemplary delivery of an IM pager mode message, according to one embodiment.

FIG. 5 is a flowchart illustrating further exemplary delivery of IM session-based mode and large message mode messages, according to one embodiment.

FIG. 6 is a flowchart illustrating further exemplary delivery of SMS and MMS messages, according to one embodiment.

FIG. 7 shows an exemplary procedure for converged messaging, responsive to receipt of a MMS message to be delivered to legacy and IP domains, according to one embodiment.

FIG. 8 shows an exemplary procedure for converged messaging, responsive to receipt of a SMS message to be delivered to legacy and IP domains, (i.e., IM for large message mode, pager mode, pager mode with content indirect, and session-based mode; MMS and SMS) to one or several parties according to one embodiment.

FIG. 9 shows an exemplary procedure for converged messaging, responsive to receipt of an IM message to be delivered to legacy and IP domains to one or several parties, according to one embodiment.

FIG. 10 is a block diagram showing exemplary aspects of a general-purpose computing device for implementing any one of the operations indicated in the procedures described with respect to FIGS. 1 through 9, according to one embodiment.

### DETAILED DESCRIPTION

### Overview

The described systems and methods permit the communication of messages (also referred to as “message data”) between a device in a packet-based network and another device connected to a wireless network providing either SMS and/or MMS. In particular embodiments, devices in the packet-based network (based on Internet Protocol, IP) use the IP Multimedia Subsystem (IMS) to communicate messages, such as Instant Messaging (IM). According to the Open Mobile Alliance (OMA), instant messages are also referred to either as “pager mode instant messages,” “session-based instant messages,” or “large message mode instant messages.”

Regarding “pager mode instant messages,” the instant message is carried in the SIP method MESSAGE using User Datagram Protocol (UDP) as transport protocol. The SIP MESSAGE message is acknowledged (e.g., using SIP 202 OK message). No SIP session is created. Regarding “session-based instant messages,” Session Initiation Protocol (SIP) is utilized to establish Message Session Relay Protocol (MSRP) sessions. MSRP is used to transmit a series of related instant messages in the context of a session. MSRP uses Transport Control Protocol (TCP) as the transport protocol. MSRP allows large instant messages. These can be segmented into several MSRP SEND messages. SIP is also used to tear down the MSRP session at the initiative of any instant messaging participant in this MSRP session).

Regarding “large message mode instant messages” (i.e., exchange of arbitrarily large and independent instant messages), large message mode includes the exchange of standalone messages that exceed the 1300-byte size limit for SIP requests over UDP as defined by IETF RFC 3261. As is the case with session mode, the SIP INVITE method is employed to establish an MSRP session. Transfer of the message then takes place at the MSRP layer. In large message mode, the MSRP session is torn down once the message transfer is complete. This contrasts with session mode, in which the MSRP session is long-lived, being torn down by an end-user).

In another embodiment, devices in the packet-based network rely on the Extensible Messaging and Presence Protocol (XMPP).

In various embodiments, devices use: (a) SMS via (i) circuit-switched domain when Short Message Service Centers can be connected to Mobile Switch Centers or (ii) packet-switched domain when Short Message Service Centers are connected to an General Packet Radio Service (GPRS); or/and (b) MMS to communicate messages. The message communication systems and methods described herein allow these devices in different networks to exchange messages, including large messages and messages with attachments, such as photographs, audio files, video files, and the like. The messages are processed and translated, as needed, to permit devices in different domains to exchange messages of any type. Thus, devices using older message communication systems can continue to communicate with newer devices using newer message communication systems.

In one particular embodiment, a messaging server receives messages intended for a destination device in a different network (e.g., packet-oriented network or wireless network providing SMS and/or MMS) than the device originating the message. The messaging server analyzes the message to determine message content and translates the message, as needed, for proper handling by systems and services in the other network. For large messages, the messaging server may store the message content in a content server (e.g., Content Server 108) and translate the message as SIP MESSAGE message. That SIP message includes a link to the stored message in the content server. The device will fetch the stored message from the content server.

In another exemplary embodiment, for large messages (i.e., beyond the payload acceptable in UDP messages—e.g., 1300 bytes when using SIP as an application protocol), the messaging server can establish a SIP session with the recipient registered in IMS, translates the message as MSRP SEND message or messages and terminate the SIP session depending on the IM mode. For messages destined to multiple devices (some as MMS and/or SMS; others as Instant Messages), short codes are used for SMS and MMS. These short codes may be matched to an Instant Messaging Group Uniform Resource Identifier (URI) to send Pager Mode Instant Messages. The messaging server shall send the SIP MESSAGE requests towards each IM Address (if this mode is supported by the messaging server, if the SIP MESSAGE message is valid, and if the service is available for the sender) and acknowledge by sending a SIP 202 “Accepted” response.

Particular embodiments described herein relate to the communication of messages such as IM messages. However, the present message communication systems and methods can be applied to any type of message or other data that is communicated between multiple devices. For example, the message communication systems and methods discussed herein can be used to communicate e.g., voicemail data, visual voicemail information, and voicemail notification messages.

These and other aspects of the systems and methods for converged messaging across legacy and IP domains are now described in greater detail.

### An Exemplary System for Communicating Messages

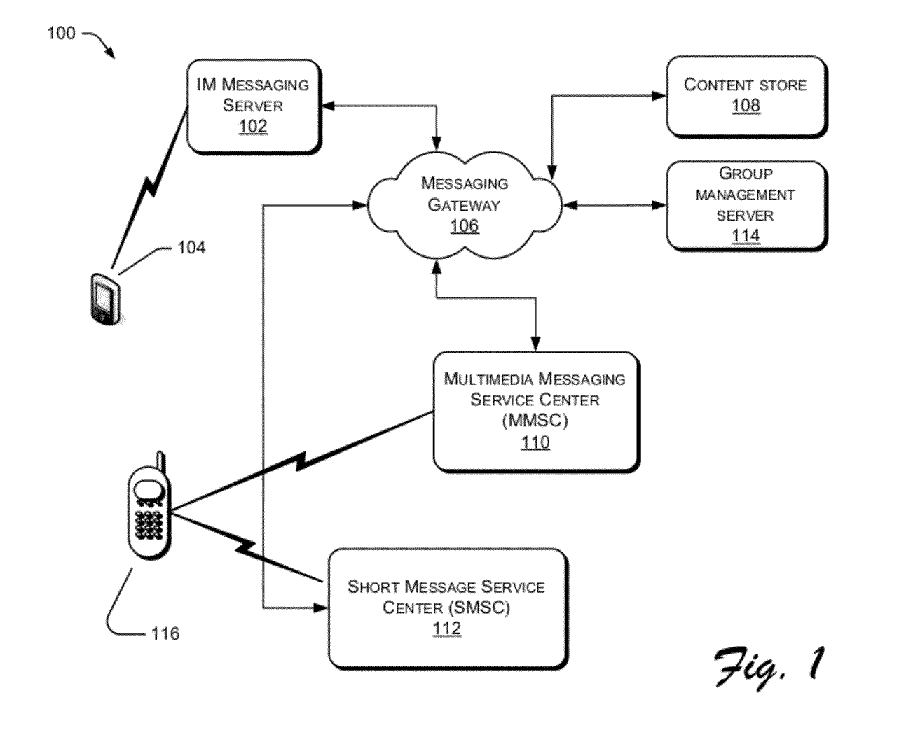

FIG. 1 shows an exemplary environment 100 capable of implementing message communication systems and methods, according to one embodiment. More particularly, FIG. 1 shows an exemplary environment for converged messaging across legacy and IP domains, wherein messages are communicated from a packet-based network to wireless network providing either SMS or MMS. Environment 100 includes messaging server 102 coupled to a communication device 104 and a messaging gateway 106. Messaging server 102 performs various message handling and message routing functions. The messaging gateway 106 is capable of routing instant messages received in a packet-oriented network to a device wireless network providing SMS and/or MMS. Examples of packet-oriented network can be SIP-based networks (including IMS-based networks) and XMPP networks. In IMS, the messaging gateway 106 is an application server coupled to a Serving Call Session Control Function, or S-CSCF (not shown). Messaging server 106 may be coupled to an S-CSCF if it is an application server as described by 3^{rd} Generation Partnership Project (3GPP) and Open Mobile Alliance (OMA). In another example implementation, the messaging server 106 is an XMPP messaging server.

Messaging gateway 106 performs various functions that assist with the communication of SMS and MMS messages to the intended recipient. The message gateway may be coupled to a content store 108 (e.g., a store/server). The content store 108 is used for pager IM mode with content indirection. The content store temporarily stores the message in this particular scenario. The termination devices retrieve that content. Messaging gateway 106 is coupled to a Multimedia Messaging Service Center (MMSC) 110 and a Short Message Service Center (SMSC) 112. In a particular implementation, the messaging gateway 106 may query a Home Subscriber Server (HSS; not shown) or Home Location Register (HLR; not shown) to route messages and/or determine how messages should be translated. If the IP network is based on IP Multimedia Subsystem, for example, messaging gateway 106 may query the Home Subscriber Server (not shown) to check if the recipient is registered in the IP network.

Communication device 104 is any device capable of communicating with messaging server 102 directly or via one or more data communication networks (e.g., IMS core network). Example communication devices 104 include cellular phones, smart phones, laptop computers, tablet computers, vehicle-based computers, portable music devices, personal digital assistants and the like. Although a single communication device 104 is shown in FIG. 1, particular implementations may include any number of communication devices coupled to messaging server 102. In a particular embodiment, communication device 104 communicates data using Session Initiation Protocol (SIP). SIP is a communication protocol used in IP network environments. SIP is used to establish sessions in the IP network that can communicate messages and other data between devices in the IP network. In another embodiment, communication device 104 communicates data using the Extensible Messaging and Presence Protocol (XMPP).

Communication device 116 is any device capable of communicating with MMSC 110 and/or SMSC 112 via one or more wired or wireless communication link. Example communication devices 116 include cellular phones, computing devices, and the like. Although FIG. 1 shows a single communication device 116, particular implementations may include any number of communication devices coupled to MMSC 110 and/or SMSC 112. Communication device 116 is shown in FIG. 1 as coupled to both MMSC 110 and SMSC 112. In particular implementations, communication device 116 may be coupled to either MMSC 110 or SMSC 112 at a particular time.

In the environment of system 100, messages may be sent as delivered in modes supported by the devices (e.g., using IMEI, an operator may determine the capabilities on handsets). For SIP devices, devices may be identified during their registration to the network (SIP registration). Registration to IMS network can be determined by querying the Home Subscriber Server (HSS). Registration to legacy network can be determined by querying the Home Location Register (HLR).

Messages may be translated in a specific protocol based on the identity of the recipient (e.g., specific Tel URI/MSISDN—a phone number, SIP URI or XMP identity). A one-to-to mapping may be performed between identities used in the different domains (MSISDN in legacy networks, Tel URI or SIP URI in SIP packet-oriented networks, XMPP identities in XMPP packet-oriented networks).

Messages may be sent as MMS when the recipient (recipients) is (are) registered on legacy networks (when SMS and MMS can be delivered) and messages may be delivered as a group (predefined or adhoc group or message size is beyond common size for SMS messages. Advertisement may be inserted in messaging requiring MMS (for legacy network). Messages may be sent as SMS when the recipient is registered on a legacy network. The information is contained in a SMS.

One or several IM modes may be supported by devices and infrastructure (i.e., network). If the maximum packet size (e.g., 200 bytes less than the path Maximum Transmission Unit, MTU, or less than 1300 bytes if the path MTU is unknown), the payload cannot be included in a SIP MESSAGE message (IM pager mode). In that case, only large message mode, session-based mode or pager mode with content indirection can support such messages. Conversion between legacy messaging protocols and XMPP can be performed similarly to conversion between messaging protocols and SIP.

When devices are registered neither on an IP network nor on a legacy network, the messages may be stored on legacy (SMS or MMS) or IM messaging server based on operator policies.

Although environment 100 shows various individual systems and components, any two or more of these systems and components may be combined into a single system or component. In one implementation, for example, messaging gateway 106 and the messaging server 102 are collocated. In another exemplary implementation, messaging gateway 106, the messaging server 102, the MMSC 110, and SMSC 112 may be collocated, and/or so on.

In one implementation, group management server 114 (e.g., an XML server) is coupled with the messaging gateway 106. Identities used for groups (i.e. group identities associated with a list of participants; short codes associated with a list of participants) may be stored in-group management server 114. The information stored in the group management server 114 may be cached in the messaging gateway 106.

### An Exemplary Procedure for Communicating Messages

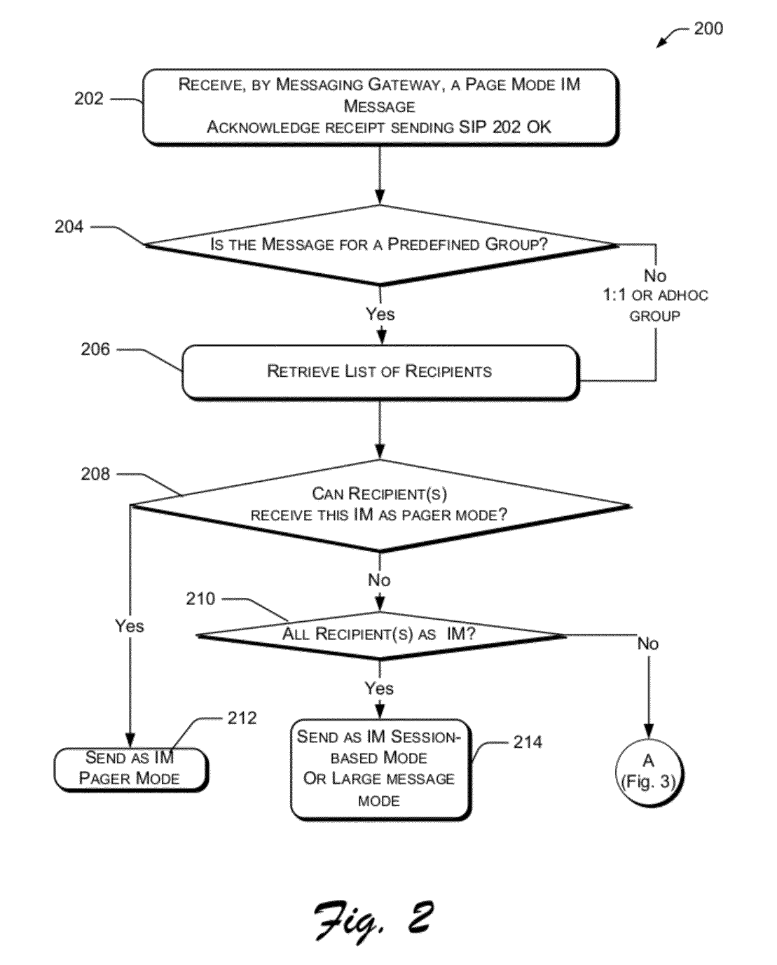

FIG. 2 shows an exemplary procedure 200 for communicating messages from a packet-oriented network as an IM pager mode message to wireless network providing SMS and/or MMS, according to one embodiment. Procedure 200 may also be utilized for communicating messages to packet-oriented network (IM session-based mode and IM large message mode) from a wireless network providing SMS and/or MMS, according to one embodiment. A communicated message may be destined to one or several parties (adhoc and predefined groups). That message may be delivered regardless of its size.

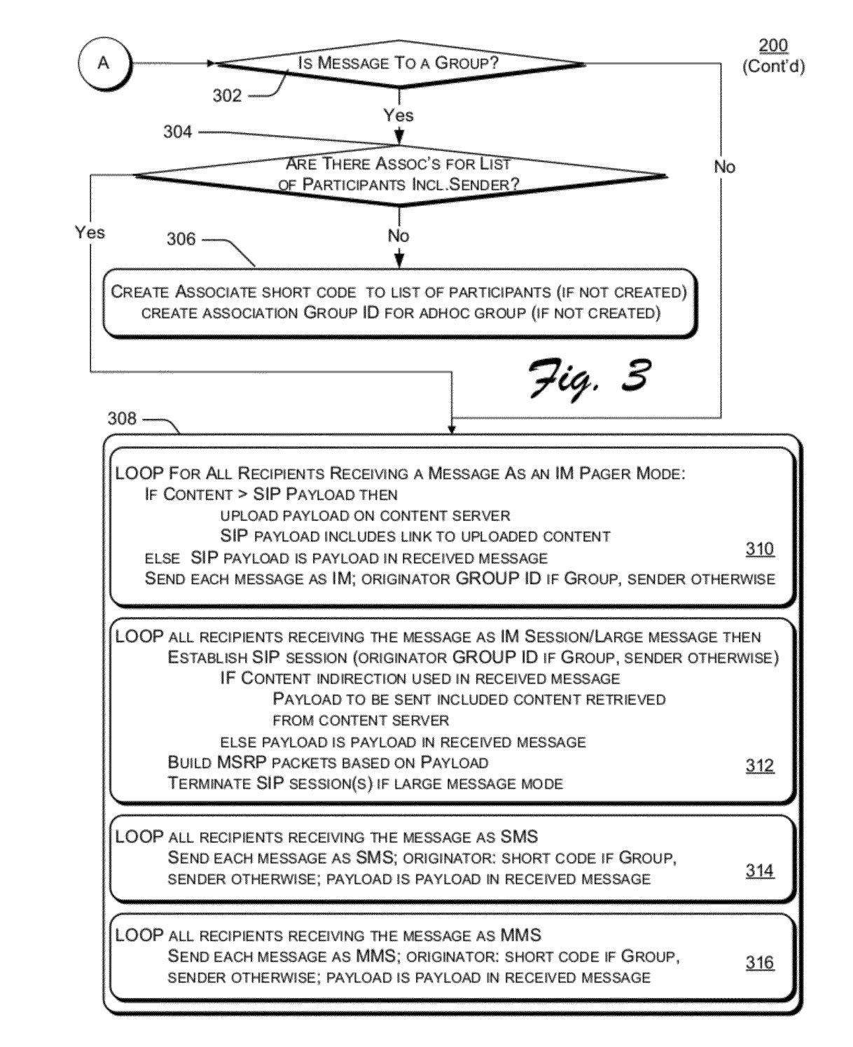

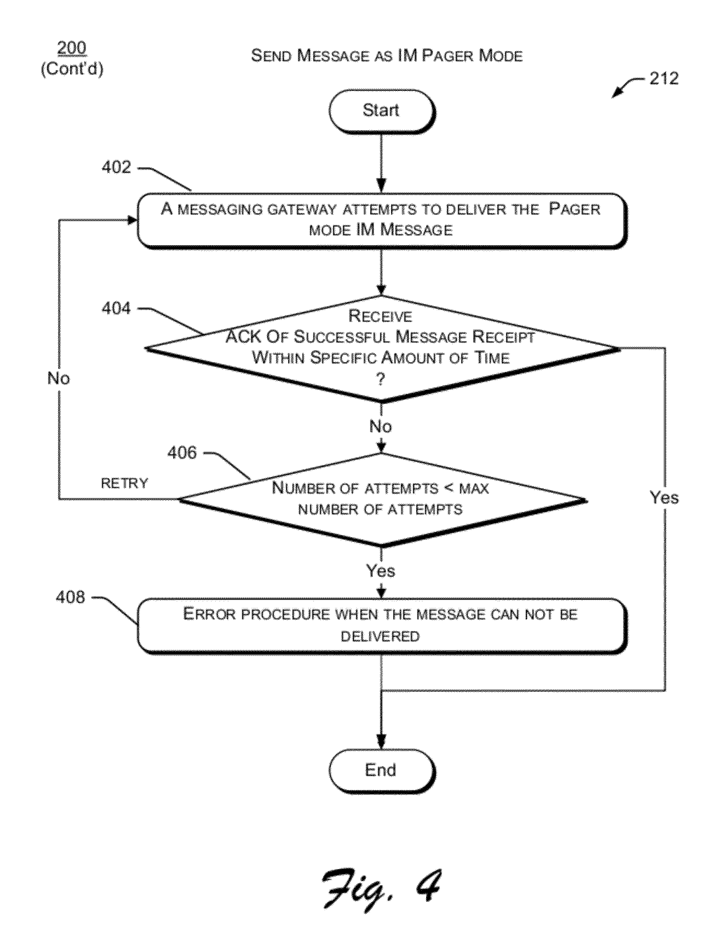

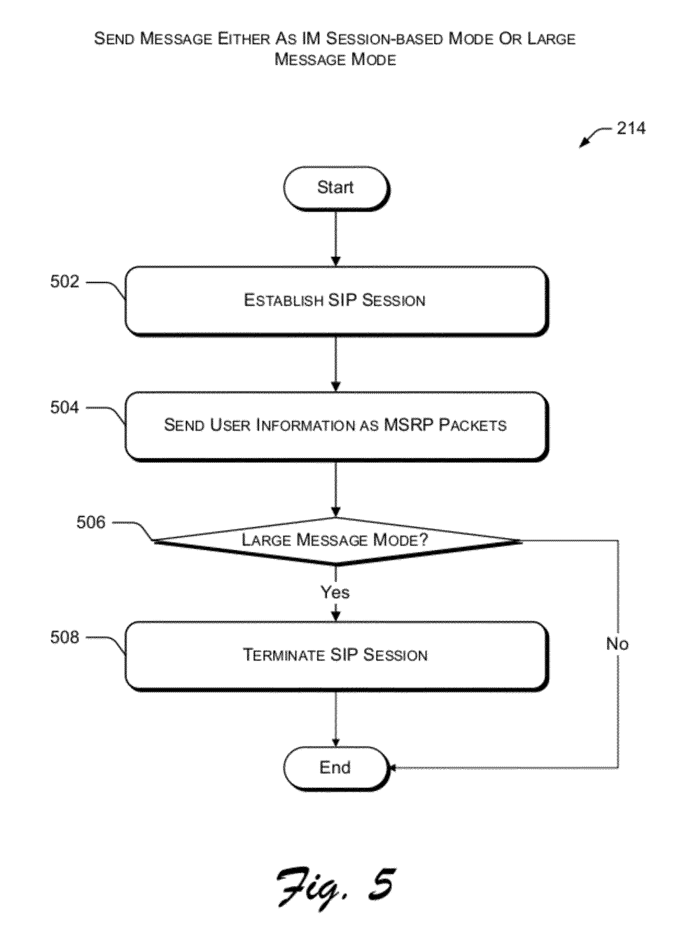

Referring to FIG. 2, operations of block 202 receive, by a messaging gateway (e.g., messaging gateway 106 of FIG. 1) a pager mode IM message (initially the message may be sent to one or several parties). In this implementation, if the message cannot be delivered as an IM pager mode message, a messaging server (102 of FIG. 1) forwards the IM message to the messaging gateway. At block 204, the messaging gateway evaluates the received message to determine if it is for members of a pre-defined group. If so, operations of block 206 fetch, by the messaging gateway, a list of participants in the pre-defined group. At block 208, the messaging gateway determines if the message can be delivered as IM as pager mode. If so, operations continue at block 212. At block 212, the messaging gateway sends the received as IM pager mode message to the targeted recipient(s). Further details of the operations of block 212 are described in detail below in reference to FIG. 4. If the operations of block 208 determine that the recipient(s) cannot receive this IM in pager mode, operations of block 210 by the messaging gateway determine if the message can be delivered as IM (i.e., session-based mode or large message mode). If so, processing continues at block 214 to send the message as IM session-based mode or large message mode. The operations of block 214 are described in detail below in reference to FIG. 5. If one or more parties cannot receive an IM pager mode message, operations of the procedure continue at FIG. 3, as indicated by on-page reference “A.”

FIG. 3 is a flowchart illustrating delivery of IM (large message mode, pager mode, pager mode with content indirect, and session-based mode), MMS and SMS regardless of the initial chosen method (IM pager mode with and without content indirection, IM large message mode and IM session-based mode, MMS, or SMS), according to one embodiment. FIG. 3 describes operations starting at on-page reference “A,” which is a continuation of the operations of procedure 200 of FIG. 2. Referring to FIG. 3, operations of block 302, by the messaging gateway, determine if the message is for a group (adhoc and predefined group). If not, operations of the procedure continue at block 308, as described below. Otherwise, operations of block 304 determine whether there are associations for that list of participants (please see block 206 of FIG. 2) including recipients and sender. If no associations have been created for these participants, the procedure at block 306 assigns a short code and a group “identificator”—an identifier/locator (e.g., a group URI if SIP is used for the packet-oriented networks, an XMPP identificator if XMPP is used for the packet-oriented networks). In one implementation, these associations may be stored in a group management server 114 of FIG. 1. In one implementation, these associations are removed/deleted from the server after a configurable period of time.

Operations of block 308 comprising blocks 310 through 316, implemented by the messaging gateway, translate the received message for each recipient as follows. Where the messaging gateway has determined that the message should be delivered to one or more recipients as IM pager mode, the process executes operations of block 310. In this scenario, the message can be sent as IM pager mode if conditions of block 310 are met for a recipient. More specifically, the messaging gateway checks size of the payload. If the payload is less than maximum packet size, the payload is included in a SIP MESSAGE message (IM pager mode). In one implementation, the payload is less than maximum packet size is it is 200 bytes less than the path Maximum Transmission Unit, MTU, or less than 1300 bytes if the path MTU is unknown. If the payload is not less than the maximum packet size, the message is sent by the messaging server as pager mode with content indirection. In this scenario, the payload is uploaded in the content server 108 and a link to that content (a URL) is included in the SIP MESSAGE message, which is sent to that recipient. Please note large messages can also be translated into IM large message as described below. In this particular implementation and because this message has been sent to a number of participants, a MIME attachment may be included in the SIP MESSAGE message listing all the participants. The recipient defined in the SIP MESSAGE may either the identity of the recipient or a group identifier (e.g., SIP URI or Tel URI).

Operations of block 312 are implemented by the procedure where the messaging gateway has determined that the message should be sent as IM large message to a recipient. More particularly, for each recipient receiving the message as IM session/large message, the messaging gateway establishes a SIP session for that recipient. In one implementation, this is accomplished by sending a SIP message with MSRP as SDP offer. That offer is accepted by the recipient by sending 200 OK. The recipient defined in the SIP MESSAGE may either the identity of the recipient or a group identifier e.g., SIP URI or Tel URI). The messaging gateway has retrieved the content from the content server if the message was sent as pager mode with content indirection (i.e., a URL was included in the original message, a SIP MESSAGE message). The messaging gateway sends MSRP SEND messages (one or several if the payload is carried by several TCP packets; that payload may either be the body of an SMS or MMS message, SIP MESSAGE message, or received MSRP packets if the message or messages were sent as IM session-based mode or IM large message mode). The messaging gateway terminates the SIP session when the transfer is done (all the MSRP packets have been acknowledged by the recipient) by sending a BYE message. This latter message is acknowledged by the recipient (by returning SIP 200 OK message).

Where the operations of block 312 determine that the message should be sent as IM session-based mode to a recipient, the messaging gateway establishes a SIP session for that recipient (by sending a SIP message with MSRP as SDP offer. In this particular implementation, such an offer is accepted by the recipient by sending 200 OK. The recipient defined in the SIP MESSAGE may either the identity of the recipient or a group identifier e.g. SIP URI or Tel URI). The messaging gateway has retrieved the content from the content server if the message was sent as pager mode with content indirection (i.e., a URL was including in the original message, a SIP MESSAGE message). The messaging gateway sends MSRP SEND messages (one or several if the payload is carried by several TCP packets; that payload may either be the body of an SMS or MMS message, SIP MESSAGE message, or received MSRP packets if the message or messages were sent as IM session-based mode or IM large message mode).

Operations of block 314 are implemented where the messaging Gateway has determined that the message should be sent as SMS. More particularly, the messaging gateway copies the payload as the body of the SMS message. Messages may be sent as SMS for small messages when the recipient is registered on legacy networks. The messaging gateway includes the payload (retrieved from the content server if the message was sent as IM pager mode with content indirection i.e., a URL was including in the original message, a SIP MESSAGE message, concatenated MSRP SEND message/messages if IM session-based mode or IM large message mode was used for the original messaging). The originator is defined as a short code. The list of participants in that chat may be including in the body of the SMS message.

Operations of block 316 are implemented where the messaging gateway has determined that the message should be sent as MMS. More particularly, the messaging gateway copies the payload as the body of the MMS message. In this scenario, messages may be sent as MMS when the recipient is registered on legacy networks (when SMS and MMS can be delivered) and messages may be delivered as a group (predefined or adhoc group) or message size is beyond common size for SMS messages. The messaging gateway includes the payload (retrieved from the content server if the message was sent as IM pager mode with content indirection, i.e., a URL was including in the original message, a SIP MESSAGE message, concatenated MSRP SEND message/messages if IM session-based mode or IM large message mode was used for the original messaging). The originator is defined as a short code. The list of participants in that chat may be including in the body of the MMS message.

FIG. 4 shows further exemplary operations of procedure 200 of FIG. 2 to process a pager mode IM message, according to one embodiment. Initially, the message may be sent to one or several parties. More particularly FIG. 4 shows further aspects of the operations of block 212. Referring to FIG. 4, the operations of block 402 deliver, by the messaging gateway, a pager mode IM Message to the one or more recipients. At block 404, the messaging gateway expects a successful message receipt. If such an acknowledgment is received, the procedure terminates. Otherwise, at block 406 the messaging gateway determines whether the number of attempts to resend has reached a threshold or maximum number of attempts to resend. If not, the procedure continues at block 402 as described above resend the message. Otherwise, operations of block 408 implement an error procedure.

FIG. 5 is a flowchart illustrating further exemplary operations of procedure 200 of FIG. 2 to deliver messages as IM session-based mode or IM large message mode, according to one embodiment. More particularly, the operations of FIG. 5 illustrate further detail of the exemplary operations of block 214 of FIG. 2 to process an IM message as IM session-based mode or IM large message mode. Referring to FIG. 5, operations of block 502 establish SIP session(s) between/among all parties. The Session Description Protocol (SDP) offer defines a messaging session using MSRP and expects acknowledgment (by receiving SIP 200 OK message). At block 504, the messaging gateway sends a series of MSRP messages including the encapsulated data. If large message mode is selected (as determined in block 506), the SIP sessions are terminated at the end of the transfer (block 508). If large message mode is not selected, but rather IM session-based mode is selected, the operations of block 214 end. In this latter scenario, please note that the SIP session remains active, for example, until one party terminates the SIP session or the SIP session expires (timeout).

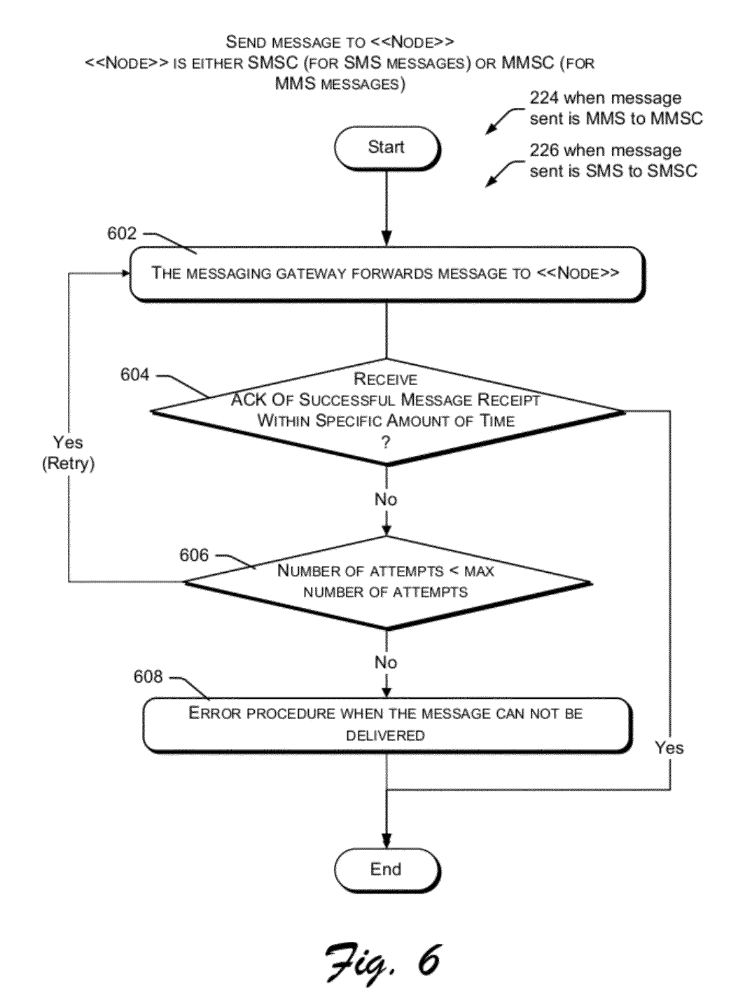

FIG. 6 is a flowchart showing an exemplary procedure for communicating an MMS (SMS) message to MMSC (SMSC) for a destination device, according to one embodiment. At block 602, a messaging gateway (e.g., the messaging gateway 106 of FIG. 1) forwards a MMS message (an SMS message) to the MMSC (SMSC). At block 604, it is determined whether an acknowledgment of successful message receipt is received within a specific amount of time. If no receipt is received, the messaging gateway will attempt to send the message again if no acknowledgment is received (see block 604) and the number of attempts is less than the maximum of attempts (as described in block 606). If the messaging gateway reaches the maximum number of attempts, the messaging gateway performs an error procedure defined in block 608.

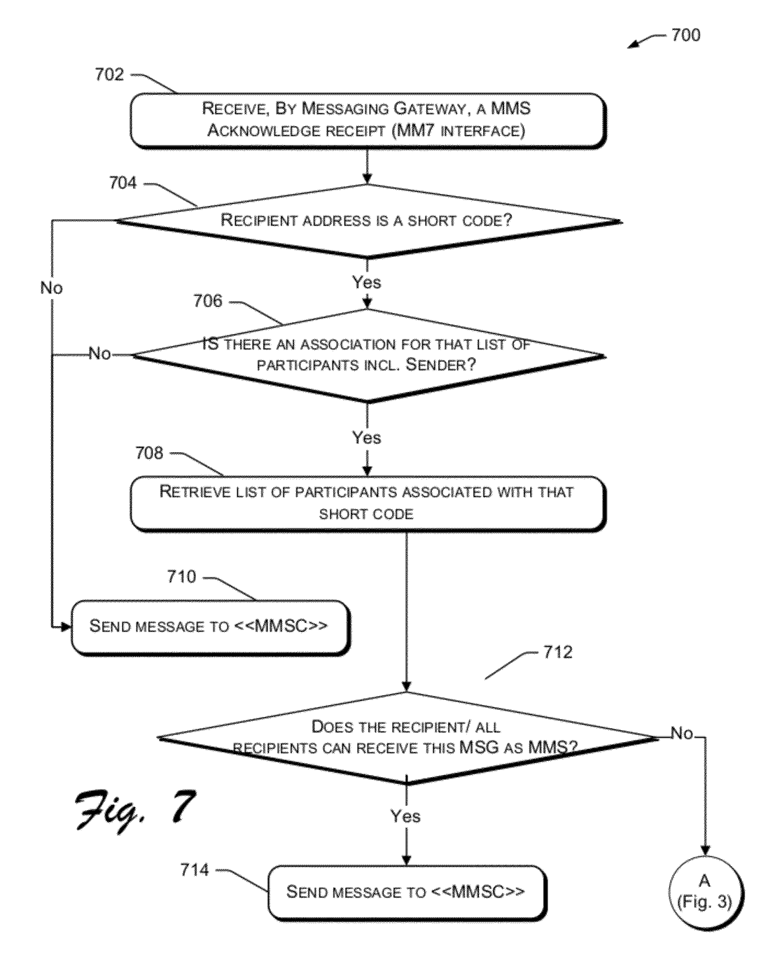

FIG. 7 is a flowchart illustrating exemplary operations of procedure 700 to process an MMS message to be delivered to legacy and IP domains, according to one embodiment. This procedure pertains to IM (for large message mode, pager mode, pager mode with content indirect, and session-based mode), and MMS and SMS to one or more parties. More particularly, operations of block 702 acknowledge receipt of the MMS message from the MMSC. The messaging gateway determines, in block 704, if recipient is defined as a short code. If so, at block 706 the messaging gateway checks if this short code has been used for group messaging (i.e., a short code has been associated to a list of participants, including the sender). If so, the messaging gateway retrieves the list of participants associated with that short code (block 708) and checks to determine if all the participants can receive an MMS in block 712. If so, the message is sent as MMS in block 714. If not, operations described in FIG. 3 are performed (one or several participants cannot receive this message as MMS), as indicated by on-page reference “A.”

If recipient defined as a short code in block 704 is not associated with a list of participants, the message is delivered as MMS in block 710.

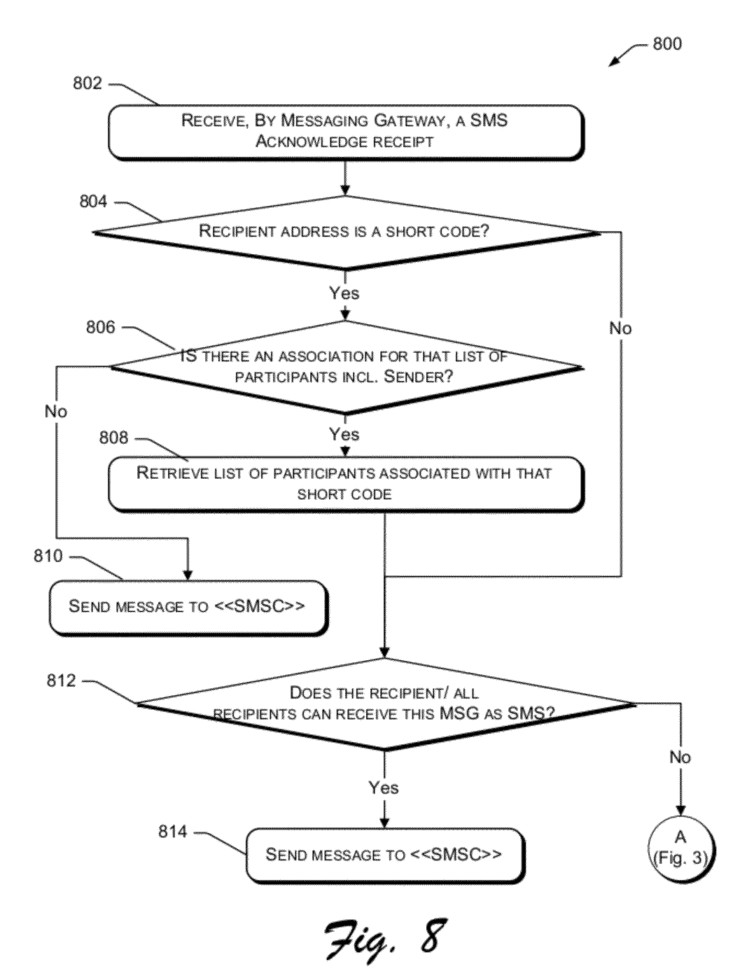

FIG. 8 is a flowchart showing exemplary operations of procedure 800 to process an SMS message to be delivered to legacy and IP domains (i.e., IM for large message mode, pager mode, pager mode with content indirect, and session-based mode; MMS and SMS) to one or several parties, according to one embodiment. Referring to FIG. 8, operations of block 802 receive an acknowledgment receipt; an acknowledgment receipt of the SMS message from the SMSC. In block 804, the messaging gateway determines if recipient is defined as a short code. If not, the operations continue at block 812, a described below. Otherwise, if the recipient address is a short code, operations continue at block 806 where the messaging gateway checks if this short code is for group messaging (e.g., associated to a list of participants (e.g., including the sender)). If the short code is for group messaging, operations of block 808 are implemented by the messaging gateway to retrieve a list of participants associated with that short code. At block 812, the procedure determines if all the participants can receive the message as an SMS. If so, the operations of block 814 send the message as SMS. Otherwise, operations of procedure 800 continue in FIG. 3, as indicated by on-page reference “A” to address the scenario where one or several participants cannot receive this message as SMS.

If recipient defined as a short code in block 804 is not associated with a list of participants (in block 806), the message is delivered as SMS in block 810.

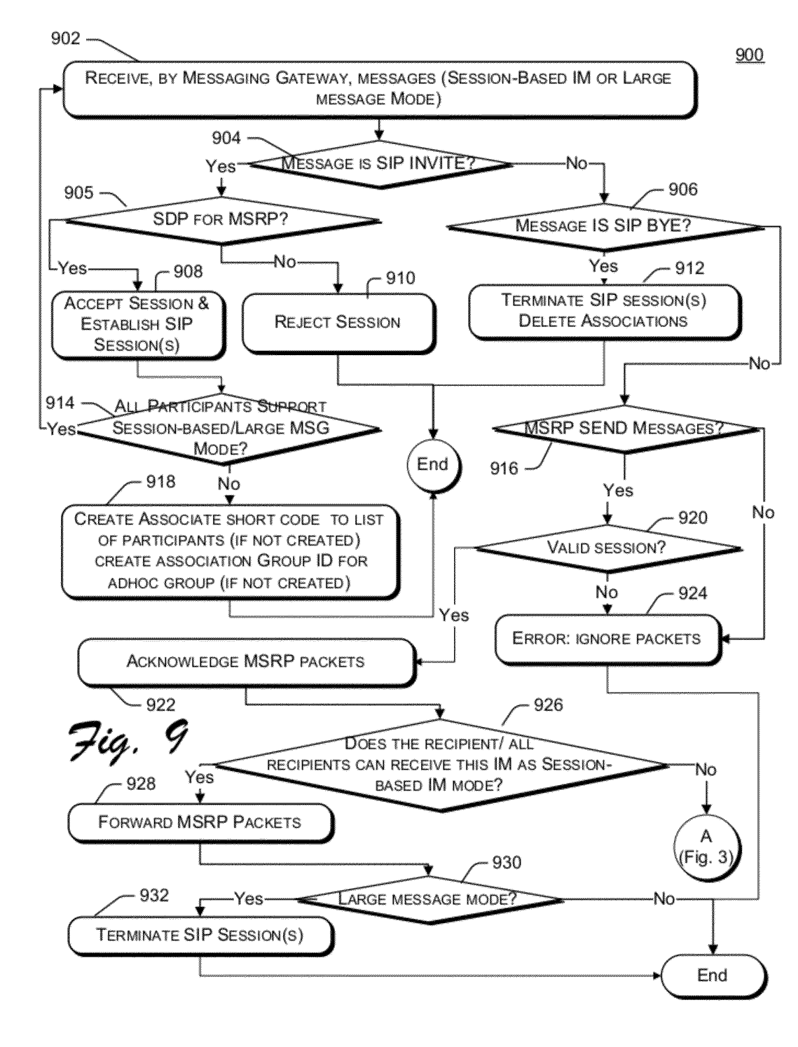

FIG. 9 is a flowchart illustrating an exemplary procedure 900 for communicating IM session-based mode/large message mode to one or several recipients in packet-oriented networks (using any IM modes) or/and legacy networks (using SMS and MMS), according to one embodiment. At block 902, a messaging gateway receives either SIP or MSRP messages. At block 904, the received messages evaluated to determine if a new SIP session has been initiated (using SIP INVITE message). If so, operations continue at block 905, wherein it is determined whether the session is for messaging. If so, operation continues at block 908 whereas SIP sessions are established between the messaging server and the messaging gateway for all parties supporting this IM mode. At block 914, the procedure determines if all parties support session-based mode or large message mode. If yes, operations continue at block 902, where the messaging gateway waits for additional messages. (For purposes of these systems and methods, the “End” designation in a figure generally indicates that the procedure either returns to a larger procedure from which it is associated, or the procedure returns to polling by the messaging gateway to wait for any additional messages.) If one or several parties do not support session-based mode or large message mode (block 914), operations continue at block 918 where the messaging Gateway defines a short code associated with that group for group messaging (adhoc and predefined groups) across legacy and IP networks. If the operations of block 905 determine that the session is not for messaging, the SIP session is terminated/rejected (the SDP offer is not accepted) at block 910.

If the operations of block 900 for determined the message is not SIP INVITE, the operations continue at block 906. Operations of block 906 determine whether SIP sessions are terminated (when the messaging gateway receives SIP BYE message). If so, the operations of block 912 acknowledge, by the messaging gateway, the SIP BYE message by returning SIP 200 OK message; it terminates all SIP sessions related that transfer and delete associations related to these parties (if created). At this point, the procedure terminates.

At block 906, it is determined whether SIP sessions are terminated (when the messaging gateway receives SIP BYE message). If not, operations of the procedure continue at block 916. Operations of block 916 determine whether MSRP SEND messages are received. If so, operations continue at block 920. At block 920, the procedure determines whether a SIP session has been established. If not, operations of block 924 ignore MSRP packets. Otherwise, if a SIP session has been established (920), operations of block 922 acknowledge MSRP packets (by sending MSRP OK messages).

At block 926, the procedure determines whether all the recipients can receive IM session-based mode messages. If not (i.e., one or several recipients support neither IM session-based IM mode nor large message mode), the procedure continues as indicated in FIG. 3 as shown by on-page reference “A.” Otherwise, operations of the procedure continue at block 928 where MSRP packets are forwarded. At block 930, the procedure determines whether IM large message mode is supported by the different parties. If so, the operations of block 932 terminate the SIP session(s) at the end of the transfer (i.e., when the last MSRP packet has been acknowledged). If IM large message mode is not supported by the different parties (IM session-based mode), the procedure ends and the SIP session(s) remains (remain) active.

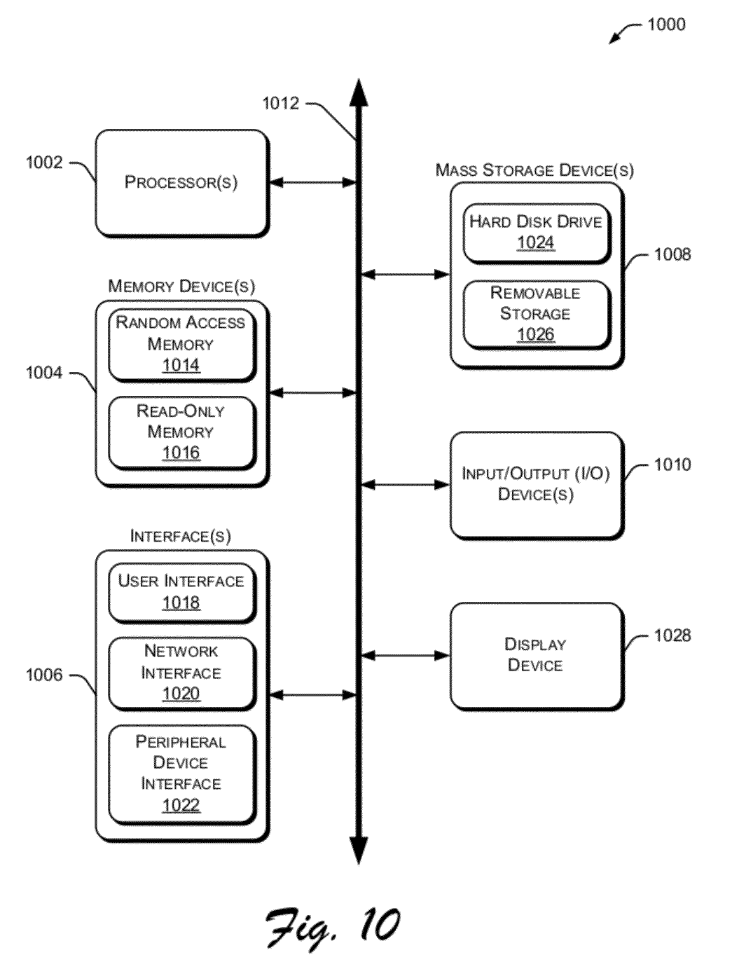

FIG. 10 is a block diagram illustrating an example-computing device 1000 for implementing one or more of the respective operations for converged messaging across legacy and IP domains, according to one embodiment. Computing device 1000 may be used to perform various procedures, such as those discussed herein. Computing device 1000 can function as a server, a client, a messaging gateway, a messaging service center, or any other computing entity. Computing device 1000 can be any of a wide variety of computing devices, such as a desktop computer, a notebook computer, a server computer, a handheld computer, a tablet computer, and the like.

Computing device 1000 includes one or more processor(s) 1002, one or more memory device(s) 1004, one or more interface(s) 1006, one or more mass storage device(s) 1008, one or more Input/output (I/O) device(s) 1010, and a display device 1028, all of which are coupled to a bus 1012. Processor(s) 1002 include one or more processors or controllers that execute instructions stored in memory device(s) 1004 and/or mass storage device(s) 1008. Processor(s) 1002 may also include various types of computer-readable media, such as cache memory.

Memory device(s) 1004 include various computer-readable media, such as volatile memory (e.g., random access memory (RAM)) 1014 and/or nonvolatile memory (e.g., read-only memory (ROM) 1016). Memory device(s) 1004 may also include rewritable ROM, such as Flash memory.

Mass storage device(s) 1008 include various computer readable media, such as magnetic tapes, magnetic disks, optical disks, solid state memory (e.g., Flash memory), and so forth. As shown in FIG. 10, a particular mass storage device is a hard disk drive 1024. Various drives may also be included in mass storage device(s) 1008 to enable reading from and/or writing to the various computer readable media. Mass storage device(s) 1008 include removable media 1026 and/or non-removable media.

I/O device(s) 1010 include various devices that allow data and/or other information to be input to or retrieved from computing device 1000. Example I/O device(s) 1010 include cursor control devices, keyboards, keypads, microphones, monitors or other display devices, speakers, printers, network interface cards, modems and the like.

Display device 1028 includes any type of device capable of displaying information to one or more users of computing device 1000. Examples of display device 1028 include a monitor, display terminal, video projection device, and the like.

Interface(s) 1006 include various interfaces that allow computing device 1000 to interact with other systems, devices, or computing environments. Example interface(s) 1006 include any number of different network interfaces 1020, such as interfaces to local area networks (LANs), wide area networks (WANs), wireless networks, and the Internet. Other interfaces include a user interface 1018 and a peripheral device interface 1022.

Bus 1012 allows processor(s) 1002, memory device(s) 1004, interface(s) 1006, mass storage device(s) 1008, and I/O device(s) 1010 to communicate with one another, as well as other devices or components coupled to bus 1012. Bus 1012 represents one or more of several types of bus structures, such as a system bus, PCI bus, IEEE 1394 bus, USB bus, and so forth.

For purposes of illustration, programs and other executable program components are shown herein as discrete blocks, although it is understood that such programs and components may reside at various times in different storage components of computing device 1000, and are executed by processor(s) 1002. Alternatively, the systems and procedures described herein can be implemented in hardware, or a combination of hardware, software, and/or firmware. For example, one or more application specific integrated circuits (ASICs) can be programmed to carry out one or more of the systems and procedures described herein.

### CONCLUSION

Although the systems and methods for message communication have been described in language specific to structural features and/or methodological operations or actions, it is understood that the implementations defined in the appended claims are not necessarily limited to the specific features or actions described. Rather, the specific features and operations of routing data are disclosed as exemplary forms of implementing the claimed subject matter.

1. A processor-implemented method for interaction between legacy messaging systems and next generation messaging systems, the method comprising:
receiving a message from a packet-switched device, wherein the message is intended for a legacy destination device;
identifying content associated with the received message;
if a size of the content exceeds a threshold value:
storing the content associated with the received message;
creating a second message in a format associated with the legacy destination device, wherein the second message includes a link to the stored message content; and
communicating the second message to the legacy destination device;
if the content size does not exceed the threshold value:
translating the message into a format associated with the destination device; and
communicating the translated message to the destination device.

2. The method of claim 1 wherein the received message is an Instant Messaging (IM) message.

3. The method of claim 1 wherein the received message includes an attachment.

4. The method of claim 1 wherein the received message is an IM message having attached information.

5. The method of claim 1 wherein the destination device supports Short Message Service (SMS) messages.

6. The method of claim 1 wherein the destination device supports Multimedia Messaging Services (MMS) messages.

7. The method of claim 1 wherein the received message is a SIP MESSAGE message defined as IM pager mode.

8. The method of claim 1 wherein the received message is a SIP MESSAGE message defined as IM pager mode with content indirection, and wherein the method further comprises storing the content associated with the received message includes storing the content in a remote content server.

9. The method of claim 1 wherein the received message is a voicemail notification message.

10. The method of claim 1 wherein the packet-switched device is a mobile communication device.

11. The method of claim 1 wherein the legacy destination device is a mobile communication device.

12. A processor-implemented method for interaction between legacy messaging systems and next generation messaging systems, the method comprising:
receiving a message (a received message) from a legacy device, wherein the message is intended for a packet-switched destination device;
identifying content;
if size of content associated with the received message exceeds a threshold value:
(a) storing the content associated with the received message;
(b) generating a second message containing a link to the stored content associated with the received message; and
(c) communicating the second message to the packet-switched destination device, wherein the packet-switched destination device retrieves the stored content using the link in the second message;
if size of content associated with the received message is less than a threshold value:
(d) translating the message into a format associated with the destination device; and
(e) communicating the translated message to the destination device.

13. The method of claim 12 wherein the received message is a Short Message Service (SMS) message.

14. The method of claim 12 wherein the received message is a Multimedia Messaging Service (MMS) message.

15. The method of claim 12 wherein the second message is an SIP MESSAGE message defined as pager mode.

16. The method of claim 12 wherein the message is an IM message including an attachment.

17. A processor-implemented method for interaction between legacy messaging systems and next generation messaging systems, the method comprising:
accepting a session with a packet-switched device;
receiving message(s) including user information from the packet-switched device, wherein the message(s) is/are intended for a legacy destination device;
translating the message(s); and
delivering the message(s) to the legacy destination device.

18. The method of claim 17 wherein the legacy destination device supports Short Message Service (SMS) messages.

19. The method of claim 17 wherein the legacy destination device supports Multimedia Message Service (MMS) messages.

20. The method of claim 17 wherein accepting the session further comprises establishing the session using Session Initiation Protocol (SIP) for exchanging messages using MSRP.

21. The method of claim 17 wherein the method further terminating the session responsive to determining that the user information has been successfully transferred as IM large message mode.

22. The method of claim 17 wherein the packet-switched device uses Extensible Messaging and Presence Protocol (XMPP) to send the message(s).

23. A processor-implemented method for interaction between legacy messaging systems and next generation messaging systems, the method comprising:
receiving a message including user information from a legacy device;
responsive to receiving the message, establishing, if no session has previously been established, a session with a packet-switched device;
translate the message (a translated message) for receipt by the packet-switched device; and
delivering the translated message to the packet-switched device.

24. The method of claim 23 wherein receiving the message, the message is received as a Short Message Service (SMS) message.

25. The method of claim 23 wherein receiving the message, the message is received as a Multimedia Message Service (MMS) message.

26. The method of claim 23 wherein establishing the session further comprises establishing the session using Session Initiation Protocol (SIP) for exchanging messages using Message Session Relay Protocol (MSRP).

27. The method of claim 23 wherein the method further comprising terminating the SIP session response to determining that the user information has been successfully transferred as IM large message mode.

28. The method of claim 23 wherein the packet-switched device supports Extensible Messaging and Presence Protocol (XMPP).

29. A processor-implemented method for interaction between legacy messaging systems and next generation messaging systems, the method comprising:
communicating messages between one or more first devices in a packet-based network and one or more second devices connected to a wireless network providing Short Message Service (SMS) or Multimedia Messaging Service (MMS), the communicating comprising:
receiving, by a messaging server, a message from a first device in a first network intended for one or more device(s) in a second network, the second network being different than the first network, the second network being a packet oriented network or a wireless network providing SMS and/or MMS;
analyzing, by the messaging server, the message to determine message content;
translating, by the messaging server, the message for proper handling by systems and services in the second network (a destination network) for delivery to the one or more second devices (targeted recipient(s)); and
sending, by the messaging server, one or more translated messages corresponding to the message to the targeted recipient(s).

30. The method of claim 29 wherein the first device uses Extensible Messaging and Presence Protocol (XMPP) to communicate Instant Messaging (IM) messages to the second device.

31. The method of claim 29 wherein if the message is targeted to multiple recipients, translating, by the messaging server, further comprises:
translating the message into one or more of MMS, SMS, and IM messages for delivery to respective ones of the multiple recipients, the translating for each recipient of the multiple recipients being a function of device characteristics for the recipient.

32. The method of claim 29 wherein if the message is targeted to multiple recipients, translating, by the messaging server, further comprises:
translating the message into one or more of SMS and MMS using short codes matched to an Instant Messaging Group Uniform Resource Identifier to send pager mode IM(s); and
wherein sending, by the messaging server, further comprises sending the pager mode IM(s) using SIP.

33. The method of claim 29 wherein the first device uses Internet Protocol Multimedia Subsystem (IMS) to communicate Instant Messaging (IM) messages to one or more of the targeted recipient(s).

34. The method of claim 33 wherein an IM message of the IM messages is a message selected from a set of messages consisting of a session-based IM, a large message mode IM, and a pager mode IM.

35. The method of claim 34 wherein the pager mode IM is with content indirection.

36. The method of claim 33 wherein an IM message of the IM messages is a pager mode IM and wherein translating, by the messaging server, further comprises using a content store for content indirection of content associated with the message, the targeted recipient(s) being configured to retrieve the content from the content store responsive to receipt of the IM message.

37. The method of claim 33, further comprising:
if the message is a large message mode IM and if a payload associated with the message is greater than a predetermined threshold payload size:
establishing, by the messaging server, a SIP session with a message recipient registered in IMS;
translating, by the messaging server, the message as MSRP SEND message(s); and
terminating, by the messaging server, the SIP session as a function of a corresponding IM mode.

38. The method of claim 33 wherein an IM message of the IM messages is a message selected from a set of messages consisting of a session-based IM, a large message mode IM, and a pager mode IM, and wherein communicating the messages further comprises:
if the IM message is a pager mode IM, not creating, by the first device, a Session Initiation Protocol (SIP) session to communicate the IM message to the second device;
if the message is a session-based IM, utilizing, by the first device, SIP to establish Message Session Relay Protocol (MSRP) session(s) for content transport associated with the message; and
if the message is a large message mode IM, implementing, by the first device, SIP INVITE to transfer the message at a MSRP layer.

39. The method of claim 38, further comprising:
if the message is a session-based IM, utilizing, by the first device or the second device, SIP to tear down the MSRP session(s); and
if the message is a large message mode IM, tearing-down, by a message recipient, a corresponding MSRP session being long-lived.
